(19) United States
(12) Patent Application Publication
(10) Pub. No.: US 2024/0353215 A1
(43) Pub. Date: Oct. 24, 2024

(54) METHOD AND SYSTEM TO DETERMINE THE MAGNETIC CENTER OF A HORIZONTALLY INSTALLED INDUCTION MOTOR

(71) Applicant: SAUDI ARABIAN OIL COMPANY, Dhahran (SA)

(72) Inventor: Mohammad Ibrahim, Abqaiq (SA)

(73) Assignee: SAUDI ARABIAN OIL COMPANY, Dhahran (SA)

(21) Appl. No.: 18/304,509

(22) Filed: Apr. 21, 2023

(51) Int. Cl. G01B 7/00

(52) U.S. Cl. CPC G01B 7/003

(57) ABSTRACT

A method for estimating a magnetic center of a motor having a pair of a rotor and a stator comprises: moving the rotor inside the stator axially to multiple axial positions; at each of the multiple axial positions, applying a constant magnitude single phase AC voltage across a stator phase of the stator and calculate a circuit impedance of the stator phase; and determining the magnetic center as one of the multiple axial positions with a maximum value of the circuit impedance. A system for estimating a magnetic center of a motor having a pair of a rotor and a stator comprises a rotor stand, a power supply, a voltmeter, and an ammeter.

### BACKGROUND

A horizontally installed induction motor has a rotor and a stator. The magnetic center for such a motor is the magnetic neutral position that the rotor assumes after oscillating back and forth along its axis of rotation while rotating at its rated speed and being supported by the sleeve bearings, once the motor is energized. The rotor tends to always assume this magnetic center because the net axial force experienced by the rotor at this neutral position is zero, or at a minimum.

As one of traditional methods of determining a magnetic center of a rotor-stator pair of a motor, the whole motor is fully assembled and a power supply is connected. Then, a lube oil system is commissioned, instrumentations are commissioned, and other preparations are performed for the motor to run uncoupled. While the motor is running, the current neutral axial position of the rotor is observed and the rotor's axial offset with respect to a stationary indicator is noted. By doing so, it can be determined how much the stator needs to be re-adjusted axially. Once the offset is determined, the motor must be de-energized and each of the steps must be performed in reverse order in order to open up the motor to access the stator. The stator then must be unbolted, re-adjusted axially, and re-secured such that the axial offset is eliminated.

Using such traditional methods, if the axial location of the rotor is substantially off from the true magnetic center while the motor is energized for the test run, the magnitude of the axial oscillation of the rotor could be substantial enough to impact the shoulder of the bearings and, thus, cause immediate and irreversible damage to both the bearings and the rotor shaft. Therefore, traditional methods for determining the magnetic center of a motor having a rotor-stator pair may be significantly time-consuming, task intensive, and subject to a risk of damaging the motor shaft and bearings.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for estimating a magnetic center of a motor having a pair of a rotor and a stator. The method includes: moving the rotor inside the stator axially to multiple axial positions; at each of the multiple axial positions, applying a constant magnitude single phase AC voltage across a stator phase of the stator and calculating a circuit impedance of the stator phase; and determining the magnetic center as one of the multiple axial positions with the maximum value of the circuit impedance.

In another aspect, embodiments disclosed herein relate to a system for estimating a magnetic center of a motor having a pair of a rotor and a stator. The system includes a rotor stand that is adjustable axially for moving the rotor to multiple axial positions inside the stator; a power supply configured to, at each of the multiple axial positions, apply a constant magnitude single phase AC voltage across a stator phase of the stator; and a voltmeter and an ammeter configured to, at each of the multiple axial positions, measure a voltage and a current of the stator phase for calculating a circuit impedance, where one of the multiple axial positions with maximum value of the circuit impedance is determined as the magnetic center.

In a further aspect, embodiments disclosed herein relate to a method for assembling a motor. The method includes: acquiring an estimated magnetic center of the motor having a pair of a rotor and a stator, the estimated magnetic center being determined without running the motor; and moving the rotor axially inside the stator to a position equivalent to the magnetic center.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a flowchart of a method for estimating a magnetic center of a motor having a pair of a rotor and a stator in accordance with one or more embodiments.

FIG. 2 shows a diagram of a system for estimating a magnetic center of a motor having a pair of a rotor and a stator in accordance with one or more embodiments.

FIG. 3 shows a further diagram of a system for estimating a magnetic center of a motor having a pair of a rotor and a stator in accordance with one or more embodiments.

FIG. 4 shows a further diagram of a system for estimating a magnetic center of a motor having a pair of a rotor and a stator in accordance with one or more embodiments.

FIG. 5 shows a further diagram of a system for estimating a magnetic center of a motor having a pair of a rotor and a stator in accordance with one or more embodiments.

FIG. 6 shows a table used with a system for estimating a magnetic center of a motor having a pair of a rotor and a stator in accordance with one or more embodiments.

FIG. 7A and FIG. 7B respectively show a plot used with a system for estimating a magnetic center of a motor having a pair of a rotor and a stator in accordance with one or more embodiments.

FIG. 8 shows a flowchart for assembling a motor in accordance with one or more embodiments.

FIG. 9 shows a diagram of assembling a motor in accordance with one or more embodiments.

### DETAILED DESCRIPTION

In the following detailed description of embodiments of the disclosure, numerous specific details are set forth to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of example, a first element is distinct from a second element, and the first element may encompass more than one element and succeed (or precede) the second element in an ordering of elements.

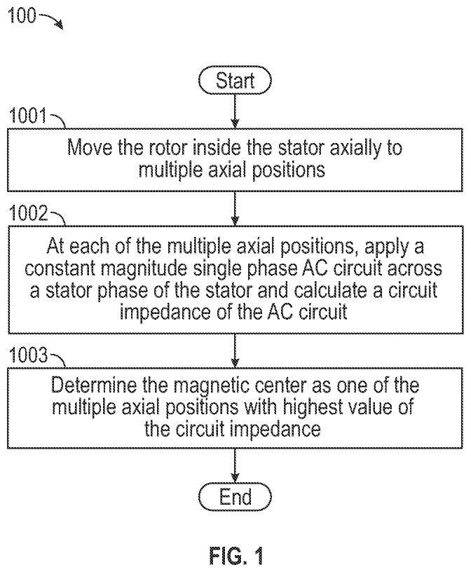

In the following descriptions of FIGS. 1-9, any component described regarding a figure, in various embodiments disclosed herein, may be equivalent to one or more like-named components described with regard to any other figure. For brevity, descriptions of these components may not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure may be interpreted as an optional embodiment which may be implemented in addition to, in conjunction with, or in place of the embodiments described with regard to a corresponding like-named component in any other figure.

It is understood that articles used in singular nouns, such as “a,” “an,” and “the,” include plural referents unless the context clearly dictates otherwise. Thus, for example, reference to “a stator phase” includes reference to one or more of such phases of a stator for a motor.

Terms, such as “approximately” and “substantially,” mean that the recited characteristic, parameter, or value do not need to be achieved exactly, but that deviations or variations, including, for example, tolerances, measurement errors, measurement accuracy limitations and other factors known to those of skill in the art, may occur in amounts that do not preclude the effect that the characteristic was intended to provide.

FIG. 1 shows a flowchart of a method 100 for estimating a magnetic center of a motor having a pair of a rotor and a stator in accordance with one or more embodiments. While FIG. 1 presents and describes various blocks sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

In block 1001, the rotor is moved inside the stator axially to multiple axial positions separately. For example, the rotor may be rotatably supported by sleeve bearings on the multiple axial positions. Therefore, an axial direction may be defined to be parallel to the rotation axis of the rotor, and a radial direction may be defined to be perpendicular to the axial direction. The stator may be secured on a base horizontally. The rotor may then be inserted inside of the stator in a correct orientation, as designed.

Sheets of press-paper, for example, ABB® Raman® paper, DuPont® Nomex® paper, and Presspahn® paper, may be laid axially across the length of the stator bore centered at the six o'clock position to spread out a weight-load of the rotor when the rotor is rested inside of the stator bore. Further, before moving the rotor inside the stator axially, it may be advantageous to adjust the rotor radially to achieve a radial clearance between the stator and the rotor based on a design air-gap value. It may also be advantageous that, before moving the rotor inside the stator axially, the rotor is positioned inside the stator axially at a mechanical center where a core of the stator and a core of the rotor are aligned in the axial direction to create symmetry. Each of the multiple axial positions may then be achieved by moving the rotor to different offset positions in axial direction from the mechanical center.

In block 1002, at each of the multiple axial positions, a constant magnitude single phase AC voltage is applied across a stator phase of the stator and calculate a circuit impedance of the stator phase. For example, at each of the multiple axial positions, a constant magnitude single phase AC voltage may be applied across a stator phase of the stator and use a voltmeter and an ammeter to measure a voltage and a current of the stator phase for calculating a circuit impedance with the formula Impedance=(Voltage/Current). In one or more embodiments, the AC voltage may drive less than 12 amperes. For example, in one or more embodiments, the AC voltage may drive any value between 10 amperes and 12 amperes or less than 5% of a rated full load current of the motor.

In block 1003, the magnetic center is estimated as one of the multiple axial positions with the maximum value of circuit impedance.

As a general principle, and not intended as a limitation to the invention, if an AC voltage is applied across a stator phase, the electrical impedance of the stator phase circuit is a function of the magnetic reluctance of the corresponding magnetic circuit. The reluctance of the stator magnetic circuit is a function of available iron on the magnetic circuit. Reluctance is the lowest and, therefore, the circuit impedance is the lowest when the rotor is absent from the stator bore. This is because there is minimal iron in the magnetic circuit to oppose the rate of change of the magnetic flux resulting from the flow of test AC current. In contrast, reluctance is the highest when the rotor is perfectly magnetically aligned or is magnetically in the mid-point within the stator bore. This is because there is maximum iron in the magnetic circuit to oppose the rate of change of the magnetic flux. This implies that, if a constant magnitude single phase AC voltage is applied across a stator phase and if the rotor's axial position is varied, the circuit impedance will vary as a function of the rotor's axial position. As expected, the circuit impedance is the maximum when the rotor is perfectly aligned within the stator bore and is magnetically in the mid-point, which is the magnetic center of the rotor-stator pair.

One or more of the following advantages may be achieved with the embodiments discussed in this disclosure. For example, by energizing with a single-phase AC as opposed to three-phase AC, no torque is generated and thus there is no risk of inadvertent rotation of the rotor during testing. As another example, maintaining the electric current of the stator under 12 amperes or under 5% of the rated full load current (FLC) of the motor, minimizes safety-related radial movement of the rotor.

In one or more embodiments, at each of the multiple axial positions, the constant magnitude single phase AC voltage is applied across one of three stator phases of the stator and the circuit impedance of the stator phase is calculated. One of the multiple axial positions with the maximum value of the circuit impedance is determined as the magnetic center of the stator-rotor pair.

In one or more embodiments, at each of the multiple axial positions, the constant magnitude single phase AC voltage is applied across two of the three stator phases of the stator separately and an average circuit impedance of the two stator phases is calculated. One of the multiple axial positions with the maximum value of the average circuit impedance is determined as the magnetic center of the stator-rotor pair.

In one or more embodiments, at each of the multiple axial positions, the constant magnitude single phase AC voltage is applied across the three stator phases of the stator separately and an average circuit impedance of the three stator phases is calculated. One of the multiple axial positions with the maximum value of the average circuit impedance is determined as the magnetic center of the stator-rotor pair.

The estimated magnetic center can be used for, for one instance, assembling a new motor with the stator and the rotor. Per usual practice, the rotor and the stator of a large high-voltage induction motor are built separately by a manufacturer. For example, the motor has a power rating of more than 370 kW at a voltage level of more than 1000 volts. Both the rotor and stator undergo the required level of electrical and mechanical tests independent of each other and are certified separately thereafter. Moreover, the rotor undergoes mechanical balancing and gets certified subsequently. The stator and the rotor are then packed for shipping in separate packaging. The rotor and the stator are never assembled and never powered up to be run as a single motor unit in the factory or at the manufacturer's workshop.

As is known, with a traditional method of assembling a new motor, it often happens that a rotor's axial alignment is off magnetic center exerts axial forces on the drive train and significantly loads up bearing shoulders, journal edges, couplings and other parts of the driven machine. Advantageously, based on one or more embodiments of the present invention described above an estimated magnetic center determined. Then, the determined estimated magnetic center may be used for the assembly and installation of the motor at the destination site where the rotor and the stator are set up together for the first time as a complete motor unit. By doing so, one or more embodiments of the present invention allow users to avoid, or decrease, damage and other undesired consequences during the assembly and installation process.

The estimated magnetic center can be used, in other instances, in a scenario where a used motor is being replaced with an identical newer one. It is often the case that only the rotor and the stator are changed out while the auxiliary and ancillary systems, as well as components, such as external bearing assembly, base, and frame, all remain unaltered. Such a change-out is generally performed during maintenance turnaround, which is always desired to be as short as possible to minimize unit unavailability. By using an estimated magnetic center of one or more embodiments, unplanned downtime may be substantially decreased. Also, in accordance with one or more embodiments, possible damage and other undesired consequences, which may occur in the traditional methods if the axial location of the rotor is substantially off from the true magnetic center, can be avoided or decreased.

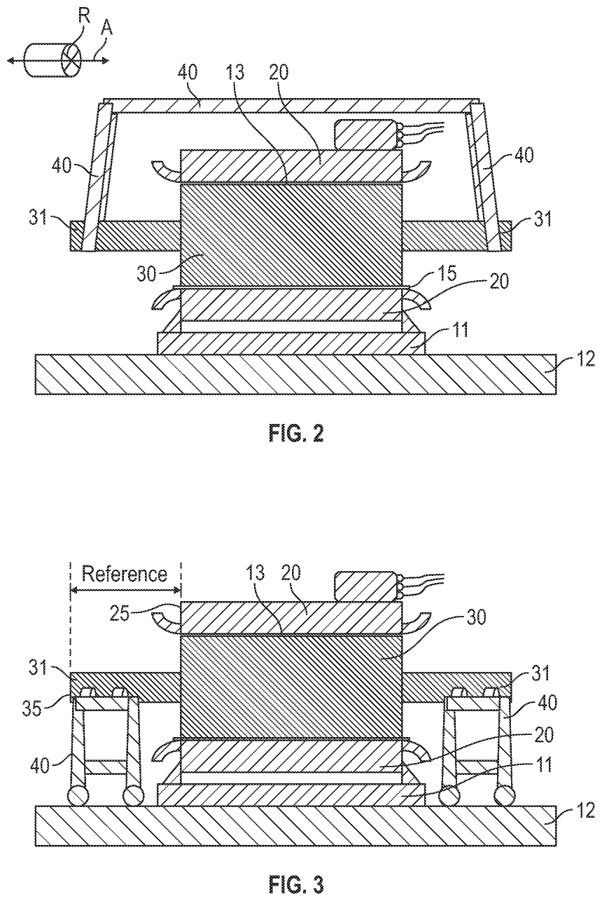

The following description made with reference to FIG. 2 through FIG. 6 describes a system for estimating a magnetic center of a motor 10 having a pair of a stator 20 and a rotor 30 (shown partially in FIG. 9) in accordance with one or more embodiments. In the figures, an axial direction A may be defined to be parallel to the rotation axis of the rotor, and a radial direction R may be defined to be perpendicular to the axial direction.

The system may be implemented, for example, in a workshop with a base 12 for setting up and horizontally securing the stator 20 with a foot 11. The rotor 30 may then be inserted inside the stator 20 at a correct orientation, as designed. Sheets of press-paper 15, for example, ABB® Raman® paper, DuPont® Nomex® paper and Presspahn® paper, may be laid axially across the length the bore of the stator 20 centered at the six o'clock position to spread out weight-load of the rotor 30 when the rotor 30 is rested inside of the bore of the stator 20.

The system may include a rotor stand 40, which is configured to be adjustable axially for moving the rotor 30 to multiple axial positions inside the stator. The rotor stand 40 may be manufactured in any form. One example of the rotor stand 40 is shown in FIG. 2 as an overhead gantry crane, which may be repositioned to perform multiple iterations of “lift-move-lower” action of the rotor 30. The “lift-move-lower” action may include: lifting the rotor 30 up a few millimeters from the stator 20 such that the rotor 30 can be freely moved; moving the rotor 30 axially to a desired location; and lowering the rotor 30 in the stator 20.

Another exemplary form of the rotor stand 40 is shown in FIG. 3 as two height-adjustable trollies under the rotor's shaft 31, one provided on each side of the rotor 30, in order to carry the rotor 30 via the shaft 31. By adjusting the height of the trollies, a radial clearance 13 close to the design air-gap value between the stator 20 and the rotor 30 can be achieved. Further, the rotor 30 may be repositioned axially within the stator bore by moving the trollies in axial direction.

As shown in FIG. 3, for example, by moving the rotor stand 40 axially, the rotor 30 may be positioned at a visual midpoint, also known as a “mechanical center,” where the stator-core (not shown) and the rotor-core (shown) are aligned in the axial direction to create the best visual symmetry. Such a “mechanical center” may be used as a reference for the multiple axial positions of the rotor 30 inside the stator 20. That is, by moving the rotor 30 in axial direction to multiple offset positions from the “mechanical center,” the rotor 30 may be repositioned at the multiple axial positions.

Thus, it is advantageous to measure the horizontal distance between the stator frame edge 25 and the shaft end-point 35 when the rotor is at the mechanical center. This distance may be used as the reference of all future measurements. All multiple axial positions are noted as offsets, either positive or negative, from the reference distance of the “mechanical center.” Also, it may be advantageous to mark the exact locations on the stator frame and shaft edge where these measurements are taken, such that future measurements are performed at the same locations.

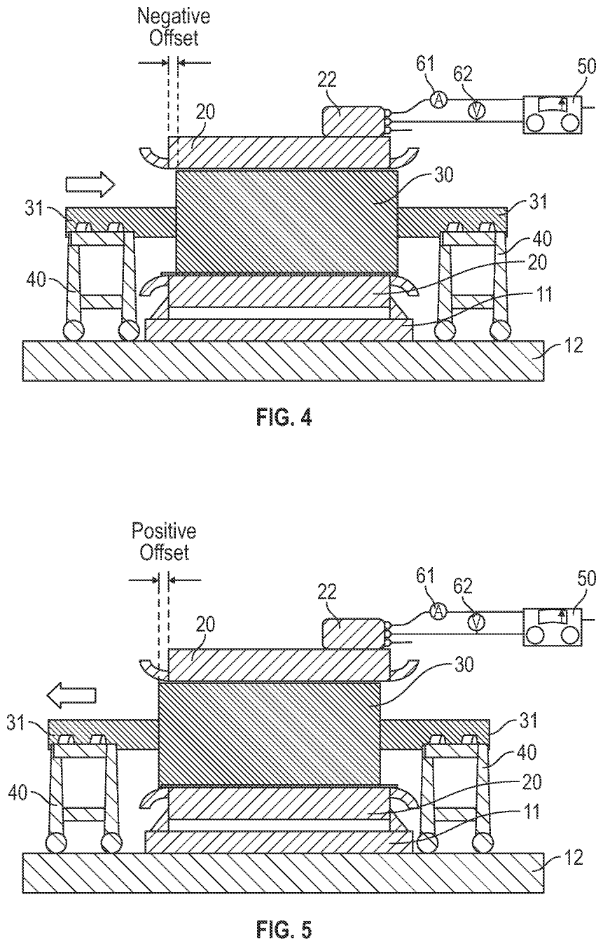

The system may further include a power supply 50, a voltmeter 62 and an ammeter 61, as illustrated in FIG. 4 and FIG. 5. The power supply 50 is configured to, at each of the multiple axial positions, apply a constant magnitude single phase AC voltage across a stator phase on the junction box 22 of the stator 20, and the voltmeter 62 and the ammeter 61 are configured to, at each of the multiple axial positions, measure a voltage and a current of the stator phase for calculating a circuit impedance with the formula: Impedance=(Voltage/Current).

In one or more embodiments, at each of the multiple axial positions, the constant magnitude single phase AC voltage is applied across one of three stator phases of the stator 20 and the circuit impedance of the stator phase is calculated. One of the multiple axial positions with the maximum value of the circuit impedance is determined as the magnetic center of the stator-rotor pair.

In one or more embodiments, at each of the multiple axial positions, the constant magnitude single phase AC voltage is applied across two of the three stator phases of the stator 20 separately and an average circuit impedance of the two stator phases is calculated. One of the multiple axial positions with the maximum value of the average circuit impedance is determined as the magnetic center of the stator-rotor pair.

In one or more embodiments, at each of the multiple axial positions, the constant magnitude single phase AC voltage is applied across the three stator phases of the stator 20 separately, and an average circuit impedance of the three stator phases is calculated. One of the multiple axial positions with the maximum value of the average circuit impedance is determined as the magnetic center of the stator-rotor pair.

For example, as illustrated in FIG. 4, the rotor 30 is moved right axially and positioned at −10.0 millimeters (“mm”) offset position from the mechanical center and secured to ensure no axial movement. Note that the term “−10.0 mm” indicates that the rotor is moved such that the stator frame edge 25 to shaft end-point 35 horizontal distance in mechanical center is reduced from the reference value by 10.0 mm.

As another example, as illustrated in FIG. 5, the rotor 30 is moved left axially and positioned at +10.0 mm offset position from the mechanical center and secured to ensure no axial movement. Note that the term “+10.0 mm” indicates that the rotor is moved such that the stator frame edge 25 to shaft end-point 35 horizontal distance is increased from the reference value by 10.0 mm.

As a result, the multiple axial positions of the rotor 30 inside the stator 20 may be achieved by axially moving and repositioning the rotor from the mechanical center for offset positions of, for example, −2.5 mm, −1.5 mm, −1.0 mm, −0.8 mm, −0.7 mm, −0.6 mm, −0.5 mm, −0.4 mm, −0.3 mm, −0.2 mm, and −0.1 mm, 0.0 mm, +0.1 mm, +0.2 mm, +0.3 mm, +0.4 mm, +0.5 mm, +0.6 mm, +0.7 mm, +0.8 mm, +1.0 mm, +1.5 mm, +2.5 mm, +5.0 mm, +7.0 mm and +10.0 mm.

From the rotor offset value and the mechanical center reference, it is possible to calculate the corresponding axial position of the rotor: Rotor axial position (mm)=Mechanical Center reference value (mm)±Offset (mm).

In one or more embodiments, the constant magnitude single phase AC voltage across a stator phase of the stator 20 drives less than 12 amperes. For example, at one of the multiple axial positions, a variable AC power supply 50, such as VARIAC®, at either 50 or 60 Hertz (“Hz”) according to the motor nameplate, is connected across a stator phase. Then, the voltmeter 62 and the ammeter 61 are connected to each other in order to measure the circuit voltage and current. Alternatively, a power quality analyzer (not shown), for example, Hioki® PQ3100 and Fluke® 1770, may be connected in order to measure the circuit voltage and current.

The variable AC power supply 50 is used to apply a single-phase voltage of the lowest magnitude while the voltage dial is at the minimum setting across the stator phase. The applied voltage may be gradually increased to observe the current reading. The increase in voltage is stopped once the current reading reaches between 10 amperes and 12 amperes, and the supply voltage is set at that level for use in further tests.

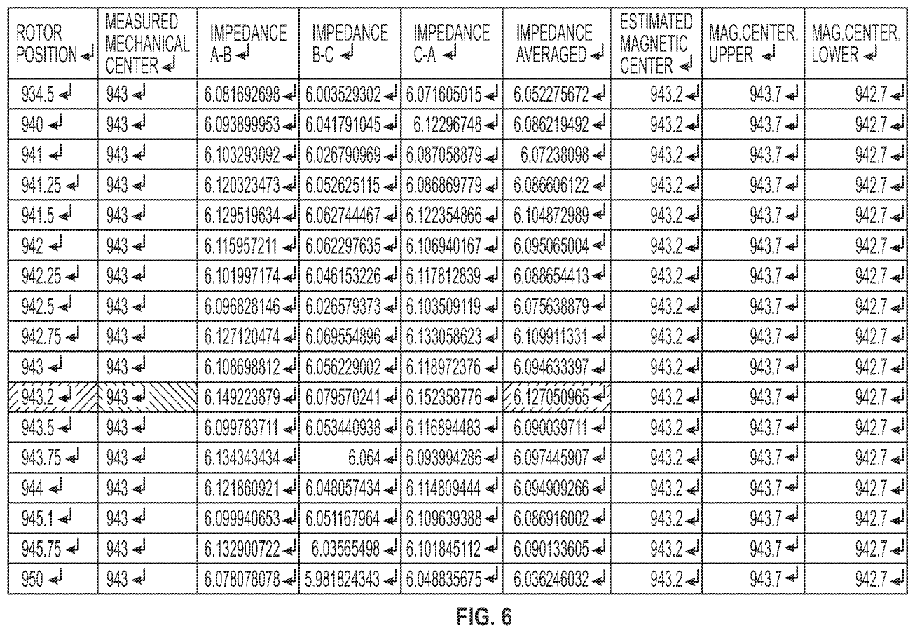

In one or more embodiments, at each of the axial positions, a single-phase voltage as set above is applied across three stator phases separately, and the voltage and current reading of each of the three stator phases are measured and noted down. For each rotor axial position, all corresponding impedance values are calculated based on the voltage and current values using formula Impedance=(Voltage/Current). The corresponding average impedance is calculated by taking arithmetic average of the impedance values of the three phases. Then, all of the values are entered into a table for subsequent calculation and analysis, as illustrated in FIG. 6. From the final outcome in the table of FIG. 6, the maximum impedance of 6.127050965Ω (Ohms) can be identified and the magnetic center of the rotor-stator pair can then be determined as the rotor position of 943.2 mm, which is +0.2 mm offset from the mechanical center position of 943.00 mm.

As illustrated in FIG. 6, a mag center upper and a mag center lower may be used to determine the magnetic center. For example, a mag center upper and a mag center lower may be determined by taking a range of +0.5 mm and −0.5 mm around the estimated magnetic center 943.2. That is, mag center upper=943.2+0.5=943.7 and mag center lower=943.2−0.5=942.7. The ±0.5 mm range is used to indicate the statistical boundaries between which the true magnetic center is most likely to lie and outside of which the magnetic center is most unlikely to lie. The main function of this range is to draw the focus into a narrow band so as to allow for further refinement if so desired. Therefore, it becomes convenient to carry out the entire test again with a significantly narrower but more granular focus in order to further pinpoint the magnetic center.

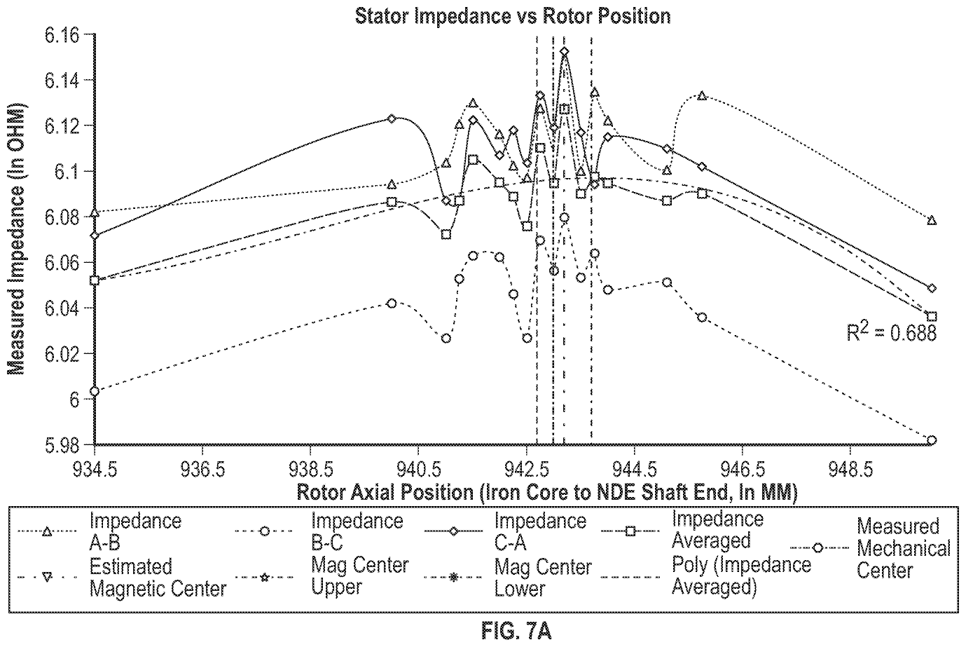

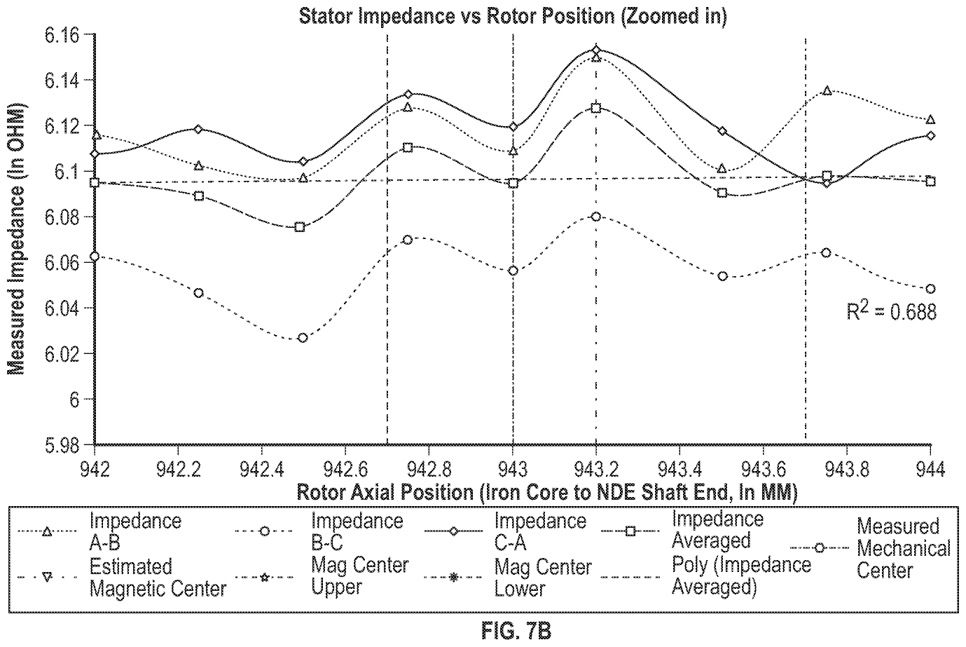

As another way to identify the magnetic center, it may be helpful to plot the impedance of the stator phases and/or the average impedance (Y-axis) vs rotor axial position (X-axis), as illustrated in FIG. 7A, which is a full view of an exemplary plot, and FIG. 7B, which is a zoomed-in view of FIG. 7A. An ideal curve of the impedances should be a “\hat{ }” (hat) shape exhibiting an impedance peak. Every value outlier is observed. Any root-cause of the deviation, for example, an incorrect voltage or current reading due to observation errors and apparatus or instrument errors, should be investigated to determine whether the cause of deviation is genuinely erroneous data. If so, it should be estimated by linear interpolation or the entire row should be removed, and the graph should be re-created. Note that, in FIGS. 7A and 7B, a polynomial trend line of the impedance averages is plotted by means of Microsoft Excel's polynomial function to better indicate where the peak is likely to occur.

Using the plot, it is possible to identify the rotor axial position value where the maximum impedance takes place, or is estimated to take place. This rotor axial position value is determined as the magnetic center position of the rotor-stator pair.

It is rare, but not impossible, to see multiple genuine “A” (hats) appearing on the plot. This is due to having multiple magnetic centers resulting from sub-standard core manufacture. In such unusual cases, one approach would be to select the highest impedance peak, which should correspond to the strongest of the magnetic centers.

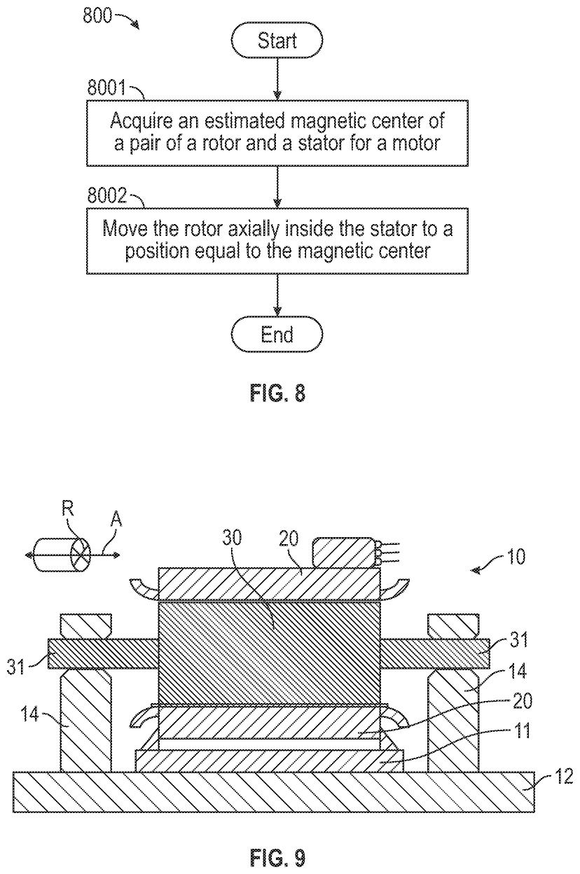

FIG. 8 is a flowchart of a method 800 for assembling a motor in accordance with one or more embodiments. While FIG. 8 presents and describes various blocks sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

In block 8001, an estimated magnetic center of the motor having a pair of a rotor and a stator is acquired. The estimated magnetic center is determined without running the motor. The estimated magnetic center may be determined by any one of methods or systems as described above. For example, the estimated magnetic center may be determined on site where the assembly takes place. Alternatively, the estimated magnetic center may be predetermined and indicated as part of the motor design drawings and operation manual.

In block 8002, the rotor axially inside the stator is moved to a position equivalent to the magnetic center. For example, the rotor may be moved with a rotor stand, e.g., in a system as described above. The rotor stand may be manufactured as an overhead gantry crane, which may be repositioned to perform multiple iterations of a “lift-move-lower” action of the rotor. Another exemplary form of the rotor stand may be two height-adjustable trollies under the rotor shaft, one provided on each side of the rotor, in order to carry the rotor via the shaft. Alternatively, this step may also be performed by any system known in the art.

The method may further include fully assembling the motor, connecting power supply to run the motor, determining a proven magnetic center when a neutral running position of the rotor matches the estimated magnetic center, and adjusting a supplied key to mark the proven magnetic center for future reference.

The method of assembling a motor may be used during the time of onsite assembly of the rotor and the stator for the first time. For example, as shown in FIG. 9, which is a diagram of assembling a motor 10 (only partially shown) in accordance with one or more embodiments, the stator 20 is firstly secured in a motor base 12, and the rotor 30 is inserted in the stator 20 with the shaft 31 supported at both ends of bearings 14. Then, the rotor is coupled with a driven machine (not shown) and rotor alignment is performed in both radial and axial directions. The stator is moved and adjusted axially such that the stator axial position with respect to the rotor is equivalent to the magnetic center axial position, as identified previously. For example, the process may include the steps of taking distance measurement from stator-frame edge to shaft-end at the marked locations, moving and adjusting the stator axially to meet the magnetic center axial position, and repeating the two steps until the stator is positioned perfectly at magnetic center position. Then, the stator is adjusted radially to fulfill the uniform airgap requirements. Once the motor is fully assembled and the power supply is connected, the motor is run uncoupled and the neutral running position of the rotor is verified as matching the magnetic center. Finally, the proven magnetic center may be used to adjust a supplied key for future reference.

The method of assembling a motor may also be used, as discussed previously, in the scenario where a used motor is being replaced with a newer one. With an estimated magnetic center of the new motor, unplanned downtime may be substantially decreased, and possible damages and other unwanted consequences, which may occur in the traditional methods if the axial location of the rotor is substantially off from the true magnetic center, can be avoided or decreased.

While the disclosure has been described with respect to a limited number of embodiments, those skilled in the art, having benefit of this disclosure will appreciate that other embodiments can be devised which do not depart from the scope of the disclosure. Accordingly, the scope of the disclosure should be limited only by the attached claims.

What is claimed is:

1. A method for estimating a magnetic center of a motor having a pair of a rotor and a stator, the method comprising:
moving the rotor inside the stator axially to multiple axial positions;
at each of the multiple axial positions, applying a constant magnitude single phase AC voltage across a stator phase of the stator and calculating a circuit impedance of the stator phase; and
determining the magnetic center as one of the multiple axial positions with a maximum value of the circuit impedance.

2. The method of claim 1, wherein the method further comprises:
at each of the multiple axial positions, applying the constant magnitude single phase AC voltage across one of three stator phases of the stator and calculating the circuit impedance of the stator phase; and
determining the magnetic center as one of the multiple axial positions with the maximum value of the circuit impedance.

3. The method of claim 1, wherein the method further comprises:
at each of the multiple axial positions, applying the constant magnitude single phase AC voltage across at least two of three stator phases of the stator separately and calculating an average circuit impedance of the at least two of three stator phases; and
determining the magnetic center as one of the multiple axial positions with a maximum value of the average circuit impedance.

4. The method of claim 1, wherein
the AC voltage drives less than 12 amperes or less than 5% of a rated full load current of the motor.

5. The method of claim 1, further comprising:
before moving the rotor inside the stator axially, adjusting the rotor radially to achieve a radial clearance between the stator and the rotor based on a predetermined air-gap value.

6. The method of claim 1, further comprising:
before moving the rotor inside the stator axially, positioning the rotor inside the stator axially at a mechanical center where the stator and the rotor are aligned in the axial direction to create symmetry.

7. The method of claim 6, wherein
the multiple axial positions comprise multiple offset positions in axial direction from the mechanical center.

8. A system for estimating a magnetic center of a motor having a pair of a rotor and a stator, the system comprising:
a rotor stand configured to be adjustable axially for moving the rotor to multiple axial positions inside the stator;
a power supply configured to, at each of the multiple axial positions, apply a constant magnitude single phase AC voltage across a stator phase of the stator; and
a voltmeter and an ammeter configured to, at each of the multiple axial positions, measure a voltage and a current of the stator phase for calculating a circuit impedance,
wherein one of the multiple axial positions with a maximum value of the circuit impedance is determined as the magnetic center.

9. The system of claim 8, wherein
the AC voltage drives less than 12 amperes or less than 5% of a rated full load current of the motor.

10. The system of claim 8, wherein
the rotor stand is further configured to be adjustable radially to achieve a radial clearance between the stator and the rotor based on a predetermined air-gap value.

11. A method for assembling a motor, the method comprising:
acquiring an estimated magnetic center of the motor having a pair of a rotor and a stator, the estimated magnetic center being determined without running the motor; and
moving the rotor axially inside the stator to a position equivalent to the magnetic center.

12. The method of claim 11, further comprising:
assembling the motor;
running the motor; and
determining a proven magnetic center when a neutral running position of the rotor, where the proven magnetic center matches the estimated magnetic center.

13. The method of claim 11, wherein the estimated magnetic center is determined by a method comprising:
moving the rotor inside the stator axially to multiple axial positions;
at each of the multiple axial positions, applying a constant magnitude single phase AC voltage across a stator phase of the stator and calculating a circuit impedance of the stator phase; and
determining the magnetic center as one of the multiple axial positions with a maximum value of the circuit impedance.

14. The method of claim 13, wherein
at each of the multiple axial positions, applying the constant magnitude single phase AC voltage across one of three stator phases of the stator and calculating the circuit impedance of the stator phase; and
determining the magnetic center as one of the multiple axial positions with the maximum value of the circuit impedance.

15. The method of claim 13, wherein
at each of the multiple axial positions, applying the constant magnitude single phase AC voltage across at least two of three stator phases of the stator separately and calculating an average circuit impedance of the at least two of three stator phases; and
determining the magnetic center as one of the multiple axial positions with the maximum value of the average circuit impedance.

16. The method of claim 13, wherein
the AC voltage drives less than 12 amperes or less than 5% of a rated full load current of the motor.

17. The method of claim 13, wherein the method further comprises:
before moving the rotor inside the stator axially, adjusting the rotor radially to achieve a radial clearance between the stator and the rotor based on a predetermined air-gap value.

18. The method of claim 13, wherein the method further comprises:
before moving the rotor inside the stator axially, positioning the rotor inside the stator axially at a mechanical center where the stator and the rotor are aligned in the axial direction to create symmetry.

19. The method of claim 18, wherein
the multiple axial positions comprise multiple offset positions in axial direction from the mechanical center.

20. The method of claim 19, wherein
the multiple offset positions comprise a negative offset position and a positive offset position from the mechanical center.
